(19) United States
(12) Patent Application Publication
(10) Pub. No.: US 2024/0413458 A1
(43) Pub. Date: Dec. 12, 2024

(54) BATTERY DEVICE AND METHOD FOR MANUFACTURING BATTERY DEVICE

(71) Applicant: TOYOTA JIDOSHA KABUSHIKI KAISHA, Toyota-shi (JP)

(72) Inventors: Takenori MIKAMI, Miyoshi-shi (JP); Hiromitsu HORI, Toyota-shi (JP); Eiichi KONDO, Toyota-shi (JP)

(73) Assignee: TOYOTA JIDOSHA KABUSHIKI KAISHA, Toyota-shi (JP)

(21) Appl. No.: 18/648,846

(22) Filed: Apr. 29, 2024

(30) Foreign Application Priority Data
Jun. 7, 2023 (JP) 2023-094223

(51) Int. Cl. H01M 50/244; H01M 50/249; H01M 50/258

(52) U.S. Cl. CPC H01M 50/244; H01M 50/249; H01M 50/258; H01M 2220/20

(57) ABSTRACT

A battery device includes a rack including a support member, and a battery unit installed on the support member of the rack. The battery unit includes a battery tray and a battery pack mounted on the battery tray. An outer peripheral portion of the battery tray includes a fitting portion configured to fit with a roller jig configured to slide the battery unit on the support member.

### CROSS-REFERENCE TO RELATED APPLICATION

This application claims priority to Japanese Patent Application No. 2023-094223 filed on Jun. 7, 2023, incorporated herein by reference in its entirety.

### BACKGROUND

### 1. Technical Field

The present disclosure relates to a battery device and a method for manufacturing the battery device.

### 2. Description of Related Art

WO 2016/129385 discloses a power storage device. The power storage device includes a storage battery board and a battery pack disposed on a support plate.

### SUMMARY

A battery device including a battery pack is considered. As the size of the battery pack becomes larger and the weight of the battery pack increases, it becomes difficult to assemble and replace the battery pack.

The present disclosure provides a technique that can improve ease of assembling and replacing the battery pack with respect to the battery device including the battery pack.

A battery device according to a first aspect of the present disclosure includes a rack including a support member and a battery unit installed on the support member of the rack. The battery unit includes a battery tray and a battery pack mounted on the battery tray. An outer peripheral portion of the battery tray includes a fitting portion configured to fit with a roller jig configured to slide the battery unit on the support member.

A battery device manufacturing method according to a second aspect of the present disclosure is a battery device manufacturing method for manufacturing the battery device. The battery device includes the rack including the support member, and the battery unit installed on the support member of the rack. The battery unit includes the battery tray and the battery pack mounted on the battery tray. The outer peripheral portion of the battery tray includes the fitting portion. The battery device manufacturing method includes attaching the roller jig configured to slide the battery unit on the support member to the fitting portion of the battery tray, and installing the battery unit in the rack by sliding the battery unit to which the roller jig is attached on the support member.

According to the present disclosure, the outer peripheral portion of the battery tray of the battery unit includes the fitting portion configured to fit with the roller jig. The roller jig is attached to the fitting portion. The battery unit to which the roller jig is attached can be easily slid on the support member. That is, “ease of movement” of the battery unit improves. Therefore, the battery unit can be easily installed (or stored) in the rack. Further, the battery unit can be easily pulled out from the rack. That is, the ease of assembling and replacing the battery unit improves.

### BRIEF DESCRIPTION OF THE DRAWINGS

Features, advantages, and technical and industrial significance of exemplary embodiments of the invention will be described below with reference to the accompanying drawings, in which like signs denote like elements, and wherein:

FIG. 1 is a schematic diagram showing a configuration example of a battery device;

FIG. 2 is a diagram showing a configuration example of a battery unit;

FIG. 3 is a diagram showing the configuration example of the battery device;

FIG. 4 is a diagram for explaining a jig and a fitting portion;

FIG. 5 is a diagram for explaining an example of a jack jig;

FIG. 6 is a diagram for explaining another example of the jack jig;

FIG. 7 is a diagram for explaining an example of a roller jig;

FIG. 8 is a diagram for explaining an example of alignment of a rail;

FIG. 9 is a diagram for explaining an example of the alignment of the rail;

FIG. 10 is a diagram for explaining an example of alignment in a lateral direction;

FIG. 11 is a diagram for explaining an example of alignment in a depth direction; and

FIG. 12 is a diagram for explaining an example of transporting the battery unit.

### DETAILED DESCRIPTION OF EMBODIMENTS

In a battery device according to a first aspect of the present disclosure, a first direction may be parallel to a direction in which a battery unit slides on a support member, and a second direction may be a direction orthogonal to the first direction. The battery unit may be installed on a surface defined by the first direction and the second direction, an outer peripheral portion of a battery tray may include a first outer peripheral portion parallel to the first direction, and the first outer peripheral portion may include a fitting portion.

In the battery device according to the first aspect of the present disclosure, a sectional shape of the fitting portion on a plane orthogonal to the first direction may be a C-shape that opens toward an outside of the battery tray in the second direction.

In the battery device according to the first aspect of the present disclosure, the fitting portion may be further configured to fit with a jack jig configured to jack up the battery unit.

In the battery device according to the first aspect of the present disclosure, an upper surface of the fitting portion may include a through hole into which a pin for fixing the fitting portion and the jack jig is inserted.

In the battery device according to the first aspect of the present disclosure, the outer peripheral portion of the battery tray may include a second outer peripheral portion parallel to the second direction, and the second outer peripheral portion may include a through hole that penetrates the second outer peripheral portion in the first direction.

In the battery device according to the first aspect of the present disclosure, the support member of a rack may be a rail that extends in the first direction, and the first outer peripheral portion of the battery tray may be installed on the rail.

In the battery device according to the first aspect of the present disclosure, a lower plate of the battery tray may include a hole in which a cam follower that moves along a side surface of the rail is attached.

In the battery device according to the first aspect of the present disclosure, a battery pack may be a battery pack configured to be mounted on a vehicle.

The battery device according to the first aspect of the present disclosure may further include an insulator interposed between the battery tray and the battery pack configured to be mounted on the vehicle.

A battery device manufacturing method according to a second aspect of the present disclosure may further include attaching the jack jig configured to jack up the battery unit to the fitting portion, and sliding, after jacking up the battery unit by using the jack jig, the battery unit to which a roller jig is attached on the support member.

In the battery device manufacturing method according to the second aspect of the present disclosure, the first direction may be parallel to the direction in which the battery unit slides on the support member, and the support member of the rack may be the rail that extends in the first direction. The battery device manufacturing method according to the second aspect of the present disclosure may further include attaching the cam follower that moves along the side surface of the rail to a lower surface of the battery tray, and sliding the battery unit to which the roller jig is attached on the support member such that the cam follower moves along the side surface of the rail.

The battery device manufacturing method according to the second aspect of the present disclosure may further include disposing the battery unit on a stand in a case, connecting a chain block provided in the case to the stand, and moving the battery unit into the rack while the chain block is operated and the stand on which the battery unit is disposed is kept horizontal.

The battery device manufacturing method according to the second aspect of the present disclosure may further include connecting an auxiliary rail to the rail of the rack.

Embodiments of the present disclosure will be described with reference to the attached drawings.

### 1. Outline of Battery Device

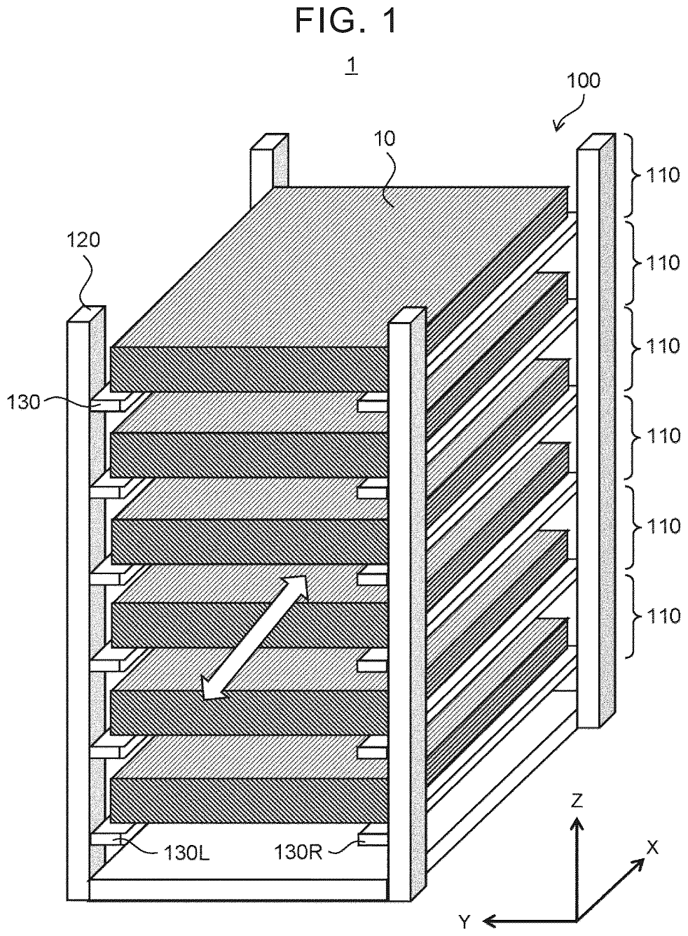

FIG. 1 is a schematic diagram showing a configuration example of a battery device 1 according to the present embodiment. The battery device 1 includes at least one battery unit 10 and a rack 100 that stores the battery unit 10. The battery unit 10 is replaceable. That is, the battery unit 10 can be inserted into from an outside of the rack 100, and the battery unit 10 can also be taken out from the rack 100.

First, a coordinate system will be described. An XY plane is a plane on which the battery unit 10 is disposed within the rack 100. A Z direction is a direction perpendicular to the XY plane. Typically, the XY plane is a horizontal plane, and the Z direction is a vertical direction. An X direction (the first direction) is a depth direction. A Y direction (the second direction) is a lateral direction orthogonal to the X direction. As will be described later, when the battery unit 10 is assembled or replaced, the battery unit 10 is moved in parallel to the X direction. That is, the battery unit 10 is inserted into the rack 100 or taken out from the rack 100 along the X direction.

The rack 100 includes storage spaces 110 for storing the battery unit 10. More specifically, the rack 100 includes a plurality of support pillars 120 that extends in the Z direction and a plurality of support members 130 parallel to the XY plane. The support member 130 is fixed to the support pillars 120. The support member 130 supports the battery unit 10. In other words, the battery unit 10 is installed on the support member 130. Therefore, the space above the support member 130 becomes the storage space 110. The storage space 110 can also be referred to as a slot. The material of the rack 100 is, for example, steel. The rack 100 may include a top plate and a door (not shown).

Typically, the battery device 1 includes a plurality of the battery units 10. In that case, the rack 100 incudes a plurality of the storage spaces 110 (slots) for storing each of the battery units 10. More specifically, the storage spaces 110 are disposed in the Z direction, that is, the storage spaces 110 are disposed in layers. A plurality of the support members 130 is provided to correspond to the storage spaces 110. The battery units 10 are installed on each of the support members 130. As a result, the battery units 10 are also disposed in layers. The battery units 10 may be electrically connected to each other. In the example shown in FIG. 1, the number of the storage spaces 110 and the battery units 10 is six. However, the number is not limited to six.

As will be described in detail later, the battery unit 10 moves (or slides) on the support member 130 along the X direction. The shape of the support member 130 is not particularly limited as long as the battery unit 10 can move (or slide) along the X direction. In the example shown in FIG. 1, the support member 130 is an elongated rail that extends in the X direction. More specifically, the support member 130 that supports the single battery unit 10 includes a pair of rails 130L, 130R. The left rail 130L is fixed to the left support pillar 120 in FIG. 1. In contrast, the right rail 130R is fixed to the right support pillar 120 in FIG. 1. The left rail 130L and the right rail 130R are parallel to each other and are both extended in the X direction. The single battery unit 10 is installed on the rails 130L, 130R.

In the following description, a case where the support members 130 are the rails 130L, 130R as shown in FIG. 1 is considered. For convenience, the rails 130L, 130R are collectively referred to as a “rail 130.” When generalizing, the “rail 130” is replaced with the “support member 130.”

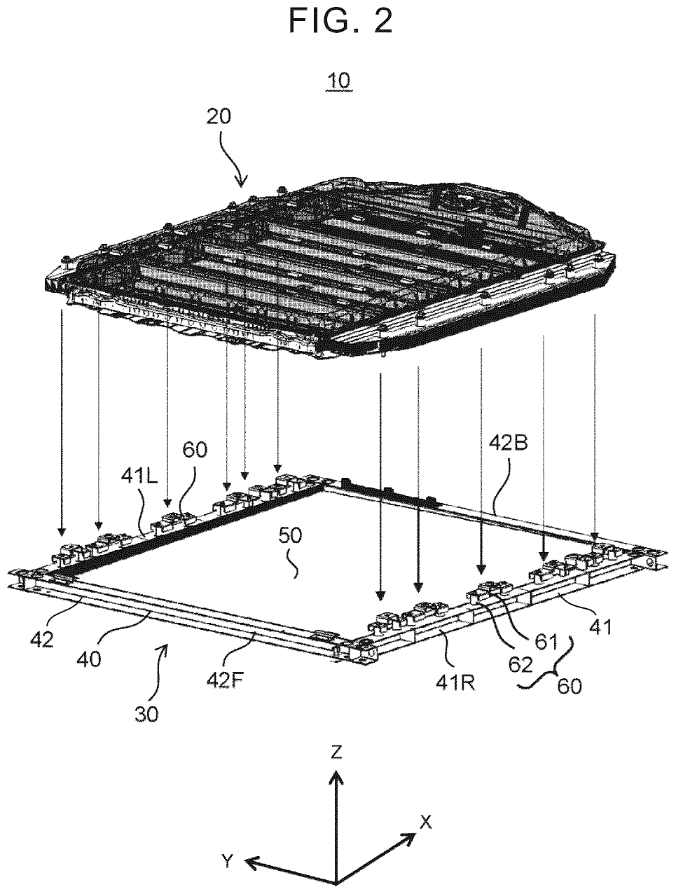

FIG. 2 is a diagram showing a configuration example of the battery unit 10. The battery unit 10 includes a battery pack 20 and a battery tray 30. The battery pack 20 includes a function as a storage battery. The battery tray 30 is a receiving tray for the battery pack 20. That is, the battery pack 20 is mounted on the battery tray 30.

As shown in FIG. 2, the battery tray 30 includes a frame 40, a lower plate 50, and a support portion 60.

The frame 40 can also be referred to as the “outer peripheral portion” of the battery tray 30. The frame 40 includes a first frame 41 (the first outer peripheral portion) parallel to the X direction and a second frame 42 (the second outer peripheral portion) parallel to the Y direction. The first frame 41 includes a left frame 41L and a right frame 41R. The second frame 42 includes a front frame 42F and a rear frame 42B. The material of the frame 40 is, for example, steel.

The lower plate 50 is surrounded by the frame 40 and forms the lower surface of the battery tray 30.

The support portion 60 is a member for supporting the battery pack 20 and is installed on the frame 40. In the example shown in FIG. 2, the support portion 60 is installed on the first frame 41. The battery pack 20 is installed on the support portion 60. For example, the support portion 60 includes a bracket 61 for fixing the battery pack 20. The support portion 60 may further include an insulator 62 for insulating between the battery pack 20 and the frame 40. The insulator 62 is interposed between the frame 40 and the bracket 61.

The battery unit 10 is configured by fixing the battery pack 20 onto the battery tray 30. Such a battery unit 10 can also be referred to as “battery subassembly.”

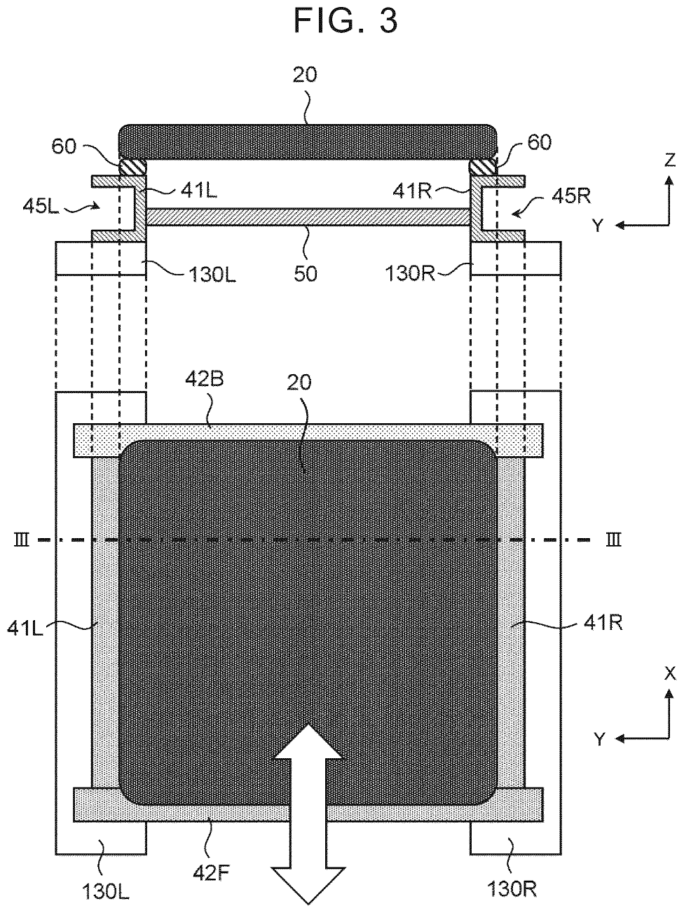

FIG. 3 is an XY plan view and a YZ sectional view showing a state in which the battery unit 10 (the battery subassembly) is installed on the rail 130 of the rack 100. The YZ sectional view shows a YZ section along a line III-III in the XY plan view. The first frame 41 parallel to the X direction is installed on the rail 130 parallel to the X direction. More specifically, the left frame 41L is installed on the left rail 130L, and the right frame 41R is installed on the right rail 130R.

Use of the battery device 1 described above is not particularly limited. For example, the battery device 1 is used as a stationary storage battery. The battery device 1 may be incorporated into an energy infrastructure. The battery device 1 may be installed as a backup power source.

Note that the battery pack 20 used in the battery device 1 according to the present embodiment may be an in-vehicle battery pack. Here, the in-vehicle battery pack refers to a battery pack developed and produced as a power source for a battery electric vehicle and a hybrid electric vehicle. Such an in-vehicle battery pack is “repurposed” as the battery pack 20 of the battery device 1.

For example, the in-vehicle battery pack that has been used in the vehicle is reused as the battery pack 20 of the battery device 1. Since output and performance of the in-vehicle battery pack are originally very high, even when the in-vehicle battery pack is used, the used in-vehicle battery pack can be used for a purpose other than the vehicle. It is expected that the number of in-vehicle battery packs produced and used will continue to increase in the future. Reusing such abundant in-vehicle battery packs as the battery pack 20 of the battery device 1 is not only preferable for the environment but also preferable from a viewpoint of securing energy.

As another example, a new in-vehicle battery pack may be used as the battery pack 20 of the battery device 1 from the beginning. Since the number of produced in-vehicle battery packs is very large, the production cost thereof is low. In other words, the in-vehicle battery pack is superior in terms of the number and the cost. It is preferable to repurpose such abundant and low-cost in-vehicle battery packs from the viewpoint of securing energy.

Note that when the in-vehicle battery pack is used as the battery pack 20 of the battery device 1, it is desirable to insulate the in-vehicle battery pack from the frame 40 from a viewpoint of pressure-resistant design. Therefore, it is desirable that the insulator 62 (see FIG. 2) is interposed between the in-vehicle battery pack and the frame 40.

### 2. Improving Ease of Movement of Battery Unit

As shown in FIG. 3, the battery unit 10 that includes the battery pack 20 is installed on the rail 130. When the battery unit 10 is assembled or replaced, the battery unit 10 moves (or slides) along the X direction on the rail 130. As the size of the battery pack 20 becomes larger and the weight of the battery pack 20 increases, it becomes difficult to move the battery unit 10 that includes the battery pack 20, making it difficult to assemble and replace the battery unit 10.

Therefore, the present embodiment proposes a technique that can improve case of assembling and replacing the battery unit 10. First, ingenuity for improving “case of movement” of the battery unit 10 will be described.

According to the present embodiment, when the battery unit 10 is assembled or replaced, a jig 200 for improving the case of the movement of the battery unit 10 is attached to the battery unit 10. The jig 200 for improving the case of the movement of the battery unit 10 includes a jack jig 210 and a roller jig 220. The jack jig 210 is a jig for jacking up the battery unit 10. The roller jig 220 is a jig for sliding the battery unit 10 on the rail 130. Before describing a specific example of the jack jig 210 and the roller jig 220, the structure on the battery unit 10 side for attaching the jig 200 will be described.

According to the present embodiment, the frame 40 (the outer peripheral portion) of the battery tray 30 of the battery unit 10 includes a “fitting portion 45” configured to fit with the jig 200. For example, the first frame 41 (the first outer peripheral portion) parallel to the X direction includes the fitting portion 45. In the example shown in FIG. 3, the sectional shape of the fitting portion 45 in the YZ plane is the C-shape that opens toward the outside of the battery tray 30 in the Y direction. For example, the sectional shape of the fitting portion 45L of the left frame 41L in FIG. 3 is the C-shape that opens toward the left. In contrast, the sectional shape of the fitting portion 45R of the right frame 41R is the C-shape that opens toward the right.

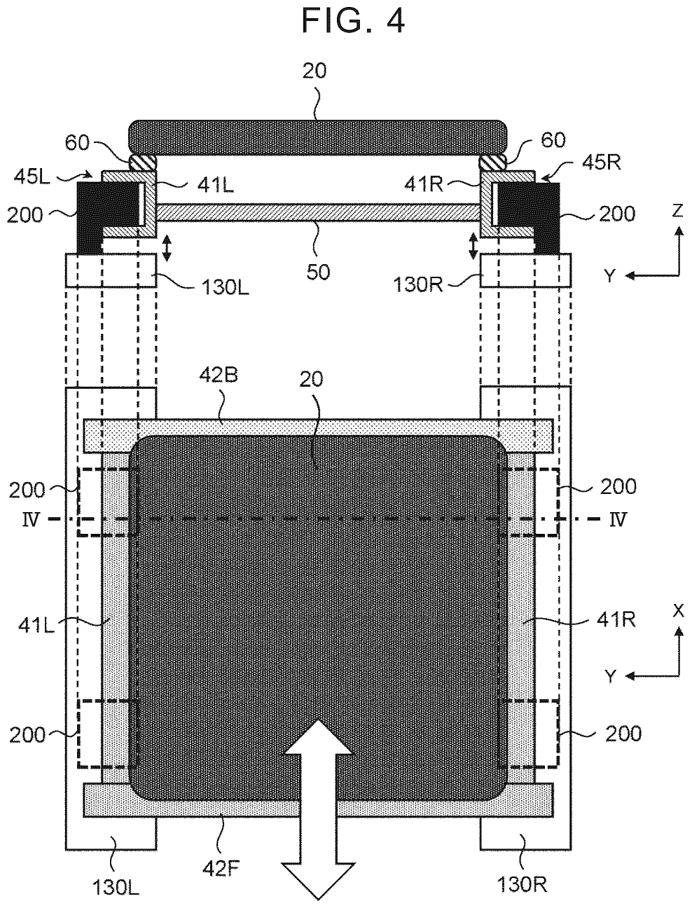

FIG. 4 is the XY plan view and the YZ sectional view showing a state in which the jig 200 is attached to the fitting portion 45 of the first frame 41. The format in FIG. 4 is similar to that of FIG. 3. The YZ sectional view shows the YZ section along a line IV-IV in the XY plan view. As shown in FIG. 4, a portion of the jig 200 is inserted into the fitting portion 45, such that the jig 200 and the fitting portion 45 (the first frame 41) are fitted together. In the example shown in FIG. 4, the jig 200 is disposed on the rail 130 and is interposed between the rail 130 and the frame 40.

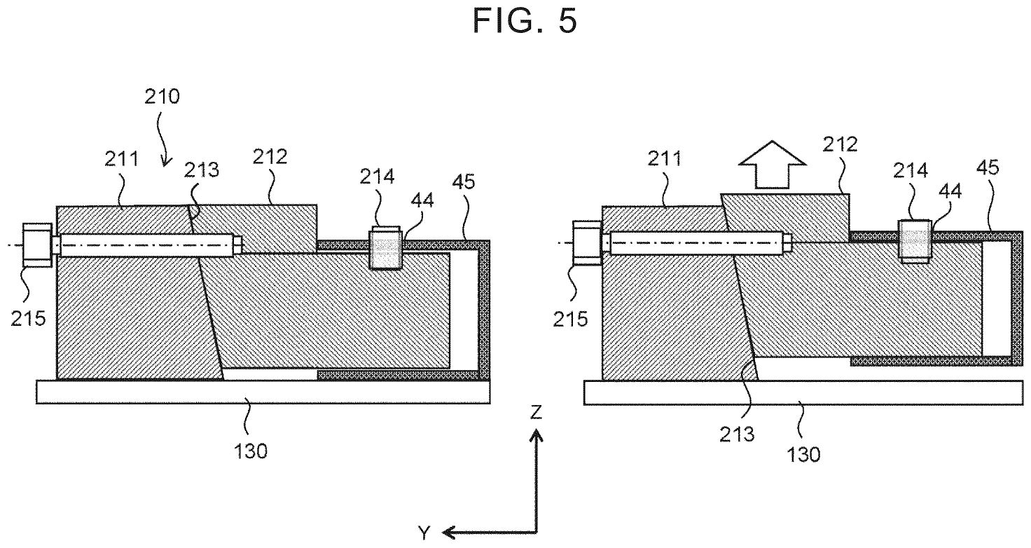

FIG. 5 is a diagram for explaining an example of the jack jig 210 for jacking up the battery unit 10. The jack jig 210 includes a first member 211 and a second member 212. The first member 211 and the second member 212 are in contact with each other on a contact surface 213. The contact surface 213 is a slope. More specifically, the contact surface 213 is an obliquely upward slope when viewed from the first member 211, and is an obliquely downward slope when viewed from the second member 212. The lower surface of the first member 211 is in contact with the rail 130. A portion of the second member 212 is inserted into the fitting portion 45 of the first frame 41, such that the jack jig 210 is attached to the fitting portion 45.

The jack jig 210 and the fitting portion 45 may be fixed with a pin 214 such that the jack jig 210 does not come off from the fitting portion 45. In this case, as shown in FIG. 5, a through hole 44 into which the pin 214 is inserted is present on the upper surface of the fitting portion 45. After the second member 212 of the jack jig 210 is inserted into the fitting portion 45, the pin 214 is inserted into the through hole 44. The pin 214 fixes the jack jig 210 (the second member 212) and the fitting portion 45.

Further, a bolt 215 (for example, a hexagonal bolt) penetrates the first member 211 in the horizontal direction and connects the first member 211 and the second member 212. In the example shown in FIG. 5, the bolt 215 penetrates the first member 211 in the Y direction. By turning the bolt 215 with a wrench (for example, a hexagonal wrench), the bolt 215 can be tightened or loosened. When the bolt 215 is tightened, force in the horizontal direction is converted into force in the Z direction via the contact surface 213 (slope), thereby pushing the second member 212 upward. By pushing up the second member 212 in the Z direction, the first frame 41, that is, the battery unit 10 is jacked up. In other words, it is possible to easily jack up the battery unit 10 by simply turning the bolt 215 with the wrench.

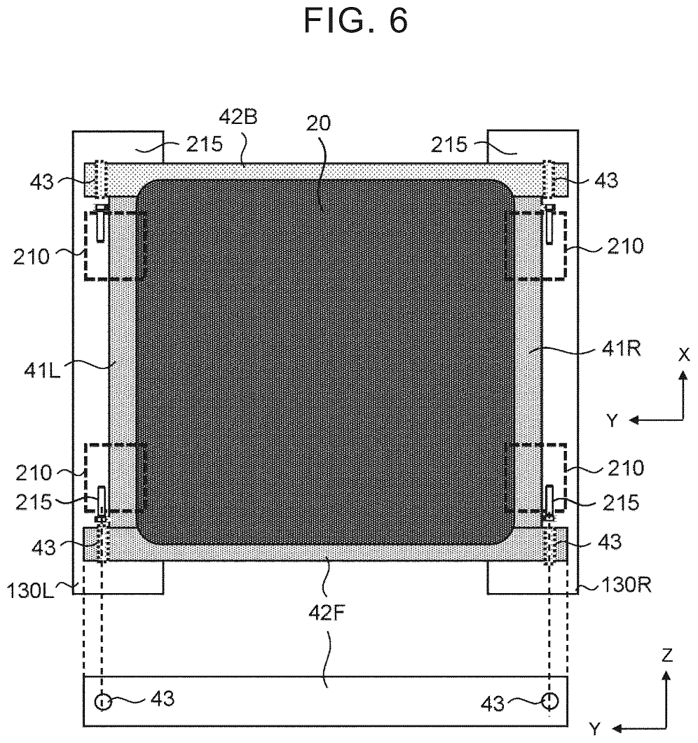

FIG. 6 is a diagram for explaining another example of the jack jig 210. In the example shown in FIG. 6, arrangement of the first member 211 and the second member 212 is rotated by 90 degrees compared to the case of FIG. 5. The bolt 215 penetrates the first member 211 in the X direction. The second frame 42 includes a through hole 43 that penetrates the second frame 42 in the X direction. A position of the through hole 43 is a position corresponding to the fitting portion 45 of the first frame 41. In particular, the position of the through hole 43 is a position corresponding to the bolt 215 of the jack jig 210 that is attached to the fitting portion 45. The wrench is inserted into the through hole 43 from the front of the second frame 42 and reaches the bolt 215 of the jack jig 210. By turning the bolt 215 with the wrench, the battery unit 10 is jacked up. The configuration shown in FIG. 6 is particularly suitable when the side space of the battery device 1 is narrow. Even when the side space of the battery device 1 is narrow, the jack jig 210 can be easily operated by inserting a wrench from the front or the rear.

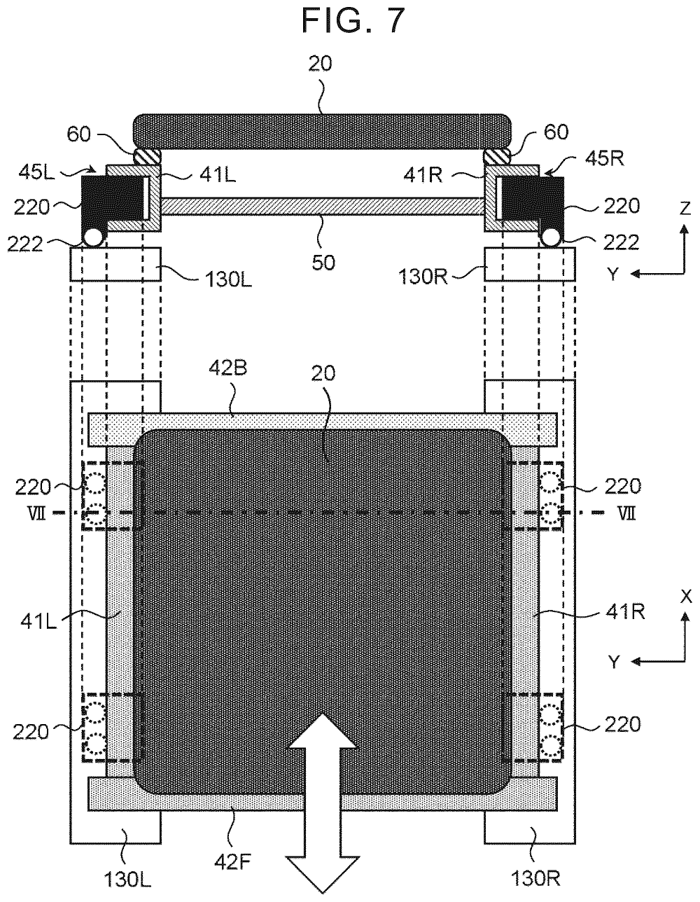

FIG. 7 is the XY plan view and the YZ sectional view for explaining an example of the roller jig 220 for sliding the battery unit 10 on the rail 130. The format in FIG. 7 is similar to that of FIGS. 3 and 4. The YZ sectional view shows the YZ section along a line VII-VII in the XY plan view. As shown in FIG. 7, a portion of the roller jig 220 is inserted into the fitting portion 45, thereby attaching the roller jig 220 to the fitting portion 45. Further, a portion of the roller jig 220 that is not inserted into the fitting portion 45 includes a roller ball 222 that contacts the rail 130. The roller ball 222 rolls on the rail 130. As a result, the battery unit 10 to which the roller jig 220 is attached slides on the rail 130 in parallel to the X direction. A groove in which the roller ball 222 rolls may be formed on the upper surface of the rail 130 in parallel to the X direction.

Note that the jack jig 210 and the roller jig 220 may be prepared separately or may be configured integrally. When the jack jig 210 and the roller jig 220 are prepared separately, the jack jig 210 is first attached to the fitting portion 45. Then, the battery unit 10 is jacked up using the jack jig 210. After jacking up, the roller jig 220 is attached to the fitting portion 45. After the roller jig 220 is attached, the jack jig 210 may be removed. Alternatively, in a case of an integrated jig, the integrated jig is attached to the fitting portion 45, and the jack-up is performed. In either case, the battery unit 10 to which the roller jig 220 is attached slides on the rail 130.

After the battery unit 10 is installed (or stored) in the rack 100, the jig 200 may be removed or may be left as is.

### Effects

As described above, according to the present embodiment, the frame 40 of the battery tray 30 of the battery unit 10 includes the fitting portion 45 configured to fit with the roller jig 220. The roller jig 220 is attached to the fitting portion 45. The battery unit 10 to which the roller jig 220 is attached can be easily slid on the rail 130. That is, the “case of movement” of the battery unit 10 improves. Therefore, the battery unit 10 can be easily installed (or stored) in the rack 100. Further, the battery unit 10 can be easily pulled out from the rack 100. That is, the ease of assembling and replacing the battery unit 10 is significantly improved. It becomes possible to assemble and replace the battery unit 10 more efficiently.

Further, since the battery unit 10 can be slid on the rail 130 by using the roller jig 220, there is no need to drag the battery unit 10 on the rail 130. Therefore, damage to a painted surface of the rail 130 is suppressed. This is preferable from a viewpoint of ensuring durability and waterproof performance of the rail 130.

As the size of the battery pack 20 becomes larger and the weight of the battery pack 20 increases, the effects obtained by the present embodiment become more significant.

### 3. Alignment

Next, ingenuity related to alignment when the battery unit 10 is assembled or replaced will be described.

### 3-1. Rail Alignment

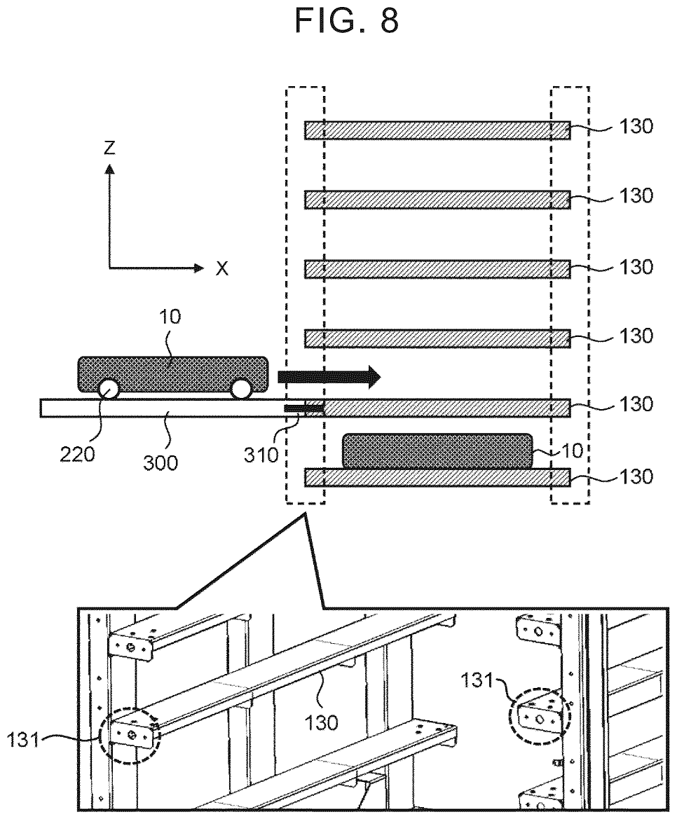

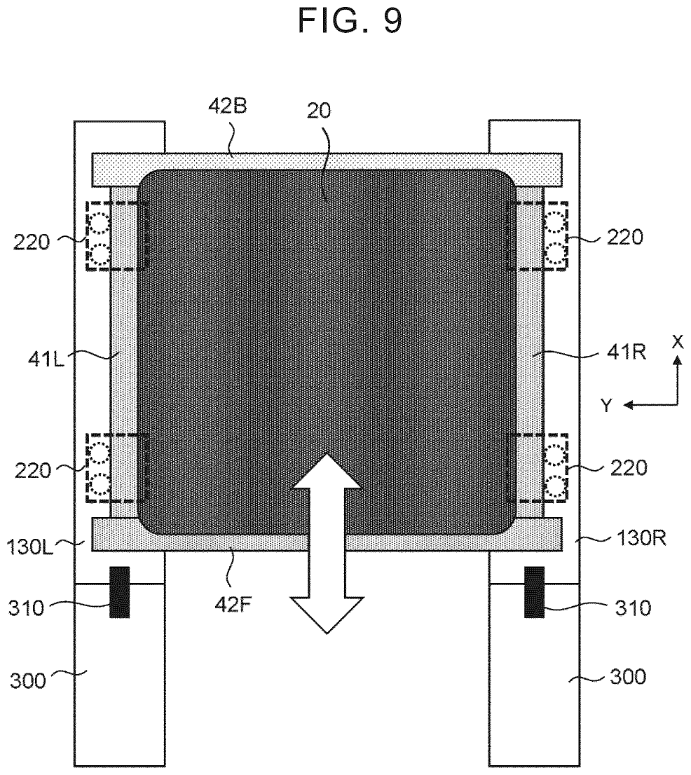

FIGS. 8 and 9 are diagrams for explaining an example of alignment of the rails 130. When the battery unit 10 is assembled or replaced, an auxiliary rail 300 outside the rack 100 is connected to the rail 130 on the rack 100 side. When the battery unit 10 is inserted into the rack 100, the battery unit 10 on the auxiliary rail 300 slides toward the rail 130 on the rack 100 side. In contrast, when the battery unit 10 is pulled out from the rack 100, the battery unit 10 on the rail 130 on the rack 100 side slides toward the auxiliary rail 300.

In order to smoothly slide the battery unit 10, it is important to align the rail 130 on the rack 100 side and the auxiliary rail 300 outside the rack 100. For this purpose, an alignment pin 310 is used. For example, as shown in FIG. 8, an alignment hole 131 into which the alignment pin 310 is inserted is formed at an end portion of the rail 130 on the rack 100 side. The rail 130 and the auxiliary rail 300 are connected such that the alignment pin 310 is inserted into the alignment hole 131. In this connected state, an upper surface and a lateral position of the rail 130 and the auxiliary rail 300 are aligned. In other words, the alignment hole 131 is formed such that the upper surfaces and the lateral positions of the rail 130 and the auxiliary rail 300 align.

In this way, the alignment of the rail 130 and the auxiliary rail 300 is accurately performed by the alignment pin 310. Therefore, it becomes possible to smoothly slide the battery unit 10 between the rail 130 and the auxiliary rail 300. This also contributes to improving the case of assembling and replacing the battery unit 10.

### 3-2. Alignment in Lateral Direction

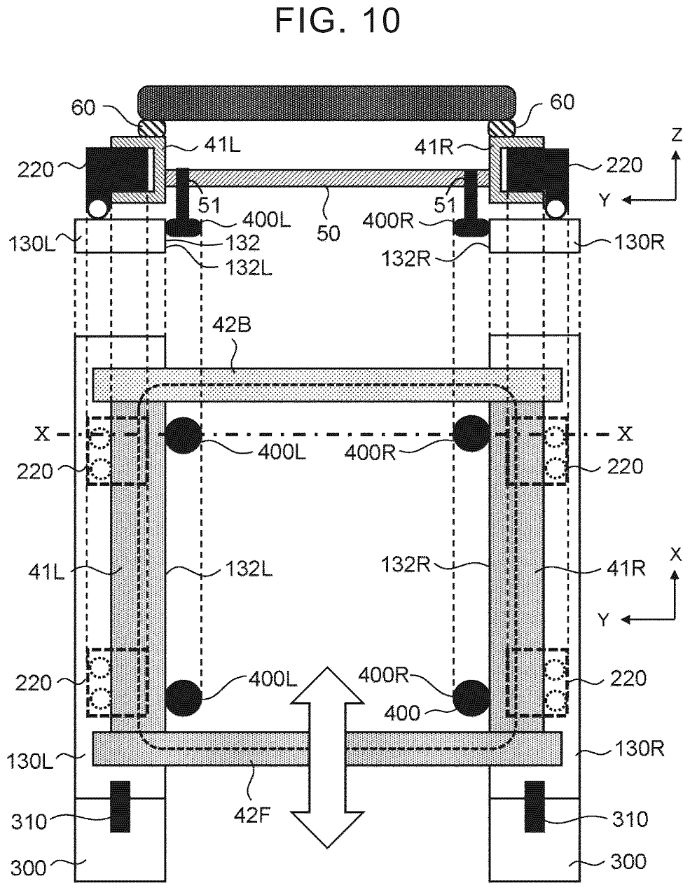

FIG. 10 is the XY plan view and the YZ sectional view for explaining an example of alignment in the lateral direction (Y direction). The format in FIG. 10 is the same as that of FIGS. 3, 4, and 7 that are previously described. The YZ sectional view shows the YZ section along a line X-X in the XY plan view. A cam follower 400 is attached to the lower plate 50 of the battery tray 30. Therefore, the lower plate 50 of the battery tray 30 includes a hole 51 in which the cam follower 400 is attached. A bolt of the cam follower 400 is inserted into the hole 51. A roller of the cam follower 400 contacts a side surface 132 of the rail 130 and moves along the side surface 132 of the rail 130 in parallel to the X direction. In other words, the hole 51 for attaching the cam follower 400 is formed in the lower plate 50 of the battery tray 30 such that the roller of the cam follower 400 comes into contact with the side surface 132 of the rail 130.

Typically, a left cam follower 400L that contacts a side surface 132L of the left rail 130L and a right cam follower 400R that contacts a side surface 132R of the right rail 130R are provided separately. The left cam follower 400L and the right cam follower 400R move along the side surface 132L of the left rail 130L and the side surface 132R of the right rail 130R, respectively.

Such a cam follower 400 reduces the battery unit 10 from deviating in the lateral direction. That is, it becomes possible to maintain a lateral position of the battery unit 10 at a predetermined position. Therefore, it becomes possible to smoothly slide the battery unit 10 along the X direction. This also contributes to improving the ease of assembling and replacing the battery unit 10.

Note that after the battery unit 10 is installed (or stored) in the rack 100, the cam follower 400 may be removed or may be left as is.

### 3-3. Alignment in Depth Direction

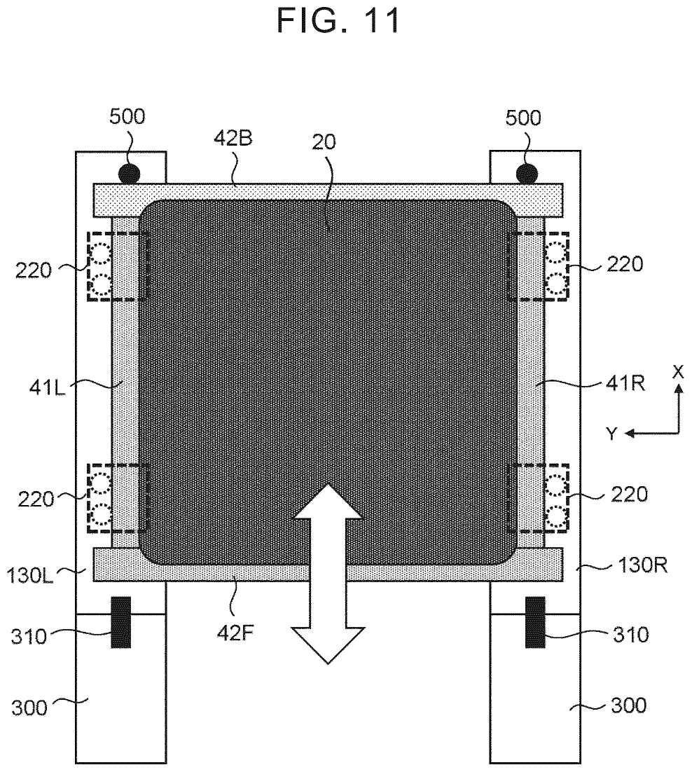

FIG. 11 is a diagram for explaining an example of alignment in a depth direction (X direction). A positioning pin 500 is installed at a predetermined position on the rail 130. The battery unit 10 that has been sliding in the X direction on the rail 130 comes into contact with the positioning pin 500 and stops. An operator only needs to push the battery unit 10 until the battery unit 10 comes into contact with the positioning pin 500 and stops. This also contributes to improving the ease of assembling the battery unit 10.

### 4. Ensuring Horizontality

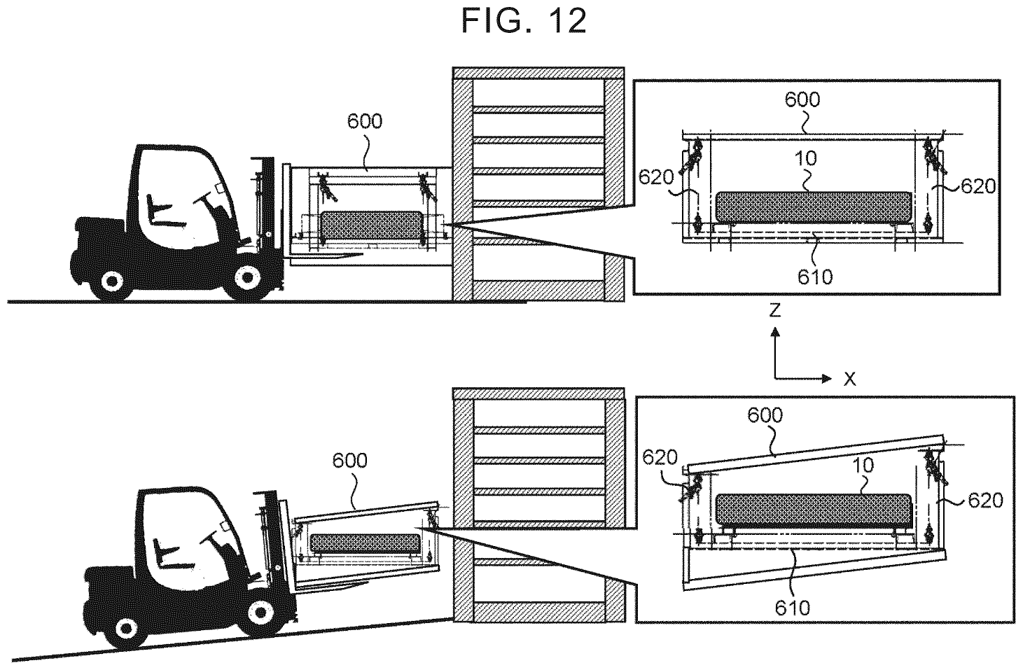

FIG. 12 is a diagram for explaining an example of transporting the battery unit 10. In the example shown in FIG. 12, the battery unit 10 is transported to the vicinity of the rack 100 by a lift. Then, the battery unit 10 is lifted to a desired height by the lift and inserted into the rack 100.

More specifically, a case 600 (a tower) for accommodating the battery unit 10 is prepared. The case 600 includes a stand 610 on which the battery unit 10 is disposed. The stand 610 may include the auxiliary rail 300. Furthermore, the case 600 is provided with a chain block 620 that is connected to the stand 610. Typically, the chain blocks 620 are provided at four corners of the case 600.

The battery unit 10 is disposed on the stand 610 inside the case 600.

Additionally, the chain block 620 is connected to the stand 610. The case 600 accommodating the battery unit 10 is transported to the vicinity of the rack 100 by the lift. Furthermore, the case 600 is lifted to the desired height by the lift. Then, the battery unit 10 is moved from inside the case 600 into the rack 100.

Here, depending on an inclination and a state of the ground where the lift is located, the case 600 may be inclined from a horizontal plane. Even in such a case, it is possible to keep the stand 610 on which the battery unit 10 is disposed horizontal by operating the chain block 620 that is provided in the case 600. The operator can move the battery unit 10 into the rack 100 while the stand 610 on which the battery unit 10 is disposed is kept horizontal. This also contributes to improving the ease of assembling the battery unit 10.

Note that a crane may be used to transport and lift the case 600 instead of the lift.

### 5. Manufacturing Method (Assembling Method) for Battery Device

The outline of the manufacturing method (assembling method) for the battery device 1 is as follows.

The operator uses the lift to transport the case 600 that accommodates the battery unit 10 to the vicinity of the rack 100. Further, the operator uses the lift to lift the case 600 to the desired height. At this time, the operator may keep the battery unit 10 horizontal by operating the chain block 620 (see Section 4).

The operator connects the auxiliary rail 300 to the rail 130 on the rack 100 side. At this time, the operator may align the rail 130 and the auxiliary rail 300 using the alignment pin 310 (see Section 3-1).

The operator attaches the jack jig 210 to the fitting portion 45 of the battery tray 30. The operator jacks up the battery unit 10 using the jack jig 210. After jacking up, the operator attaches the roller jig 220 to the fitting portion 45. Alternatively, the jack jig 210 and the roller jig 220 may be integrally configured. The operator slides the battery unit 10 to which the roller jig 220 is attached on the rail 130, and installs (or stores) the battery unit 10 in the rack 100 (see Section 2).

The operator may attach the cam follower 400 to the lower plate 50 of the battery tray 30. In this case, the operator slides the battery unit 10 to which the roller jig 220 is attached on the rail 130 such that the cam follower 400 moves along the side surface 132 of the rail 130 (see Section 3-2).

The operator pushes the battery unit 10 until the battery unit 10 contacts the positioning pin 500 and stops.

In this way, the battery unit 10 is installed in the rack 100, and the battery device 1 is completed.

What is claimed is:

1. A battery device comprising:
a rack including a support member; and
a battery unit installed on the support member of the rack, wherein:
the battery unit includes a battery tray and a battery pack mounted on the battery tray; and
an outer peripheral portion of the battery tray includes a fitting portion configured to fit with a roller jig configured to slide the battery unit on the support member.

2. The battery device according to claim 1, wherein:
a first direction is parallel to a direction in which the battery unit slides on the support member;
a second direction is a direction orthogonal to the first direction;
the battery unit is installed on a surface defined by the first direction and the second direction;
the outer peripheral portion of the battery tray includes a first outer peripheral portion parallel to the first direction; and
the first outer peripheral portion includes the fitting portion.

3. The battery device according to claim 2, wherein a sectional shape of the fitting portion on a plane orthogonal to the first direction is a C-shape that opens toward an outside of the battery tray in the second direction.

4. The battery device according to claim 2, wherein the fitting portion is further configured to fit with a jack jig configured to jack up the battery unit.

5. The battery device according to claim 4, wherein an upper surface of the fitting portion includes a through hole into which a pin for fixing the fitting portion and the jack jig is inserted.

6. The battery device according to claim 4, wherein:
the outer peripheral portion of the battery tray includes a second outer peripheral portion parallel to the second direction; and
the second outer peripheral portion includes a through hole that penetrates the second outer peripheral portion in the first direction.

7. The battery device according to claim 2, wherein:
the support member of the rack is a rail that extends in the first direction; and
the first outer peripheral portion of the battery tray is installed on the rail.

8. The battery device according to claim 7, wherein a lower plate of the battery tray includes a hole in which a cam follower that moves along a side surface of the rail is attached.

9. The battery device according to claim 1, wherein the battery pack is a battery pack configured to be mounted on a vehicle.

10. The battery device according to claim 9, further comprising an insulator that is interposed between the battery tray and the battery pack configured to be mounted on the vehicle.

11. A battery device manufacturing method for manufacturing a battery device, the battery device including a rack that includes a support member, and a battery unit that is installed on the support member of the rack, the battery unit including a battery tray and a battery pack that is mounted on the battery tray, and an outer peripheral portion of the battery tray including a fitting portion, the battery device manufacturing method comprising:
attaching a roller jig configured to slide the battery unit on the support member to the fitting portion of the battery tray; and
installing the battery unit in the rack by sliding the battery unit to which the roller jig is attached on the support member.

12. The battery device manufacturing method according to claim 11, further comprising:
attaching a jack jig configured to jack up the battery unit to the fitting portion; and
sliding the battery unit to which the roller jig is attached on the support member, after jacking up the battery unit using the jack jig.

13. The battery device manufacturing method according to claim 11, a first direction being parallel to a direction in which the battery unit slides on the support member, and the support member of the rack being a rail that extends in the first direction, the battery device manufacturing method, further comprising:
attaching a cam follower that moves along a side surface of the rail) to a lower surface of the battery tray; and
sliding the battery unit to which the roller jig is attached on the support member such that the cam follower moves along the side surface of the rail.

14. The battery device manufacturing method according to claim 11, further comprising:
disposing the battery unit on a stand inside a case;
connecting a chain block that is provided in the case to the stand; and
moving the battery unit into the rack while the chain block is operated and the stand on which the battery unit is disposed is kept horizontal.

15. The battery device manufacturing method according to claim 11, further comprising connecting an auxiliary rail to a rail of the rack.

16. The battery device manufacturing method according to claim 13, further comprising connecting an auxiliary rail to the rail of the rack.
